(19) United States
(12) Patent Application Publication
(10) Pub. No.: US 2026/0330853 A1
(43) Pub. Date: Oct. 22, 2026

(54) SYSTEM AND METHOD FOR VIDEO INTELLIGENCE SERVICE

(71) Applicant: VIMEO.COM, INC., New York, NY (US)

(72) Inventors: Yaron GUROVICH, Rehovot (IL); Alon FAKTOR, Rehovot (IL); Naama BEN-DOR, Yavne (IL); Yedidya HYAMS, Ramat Gan (IL); Dolav NITAY, Modi'in-Maccabim-Re'ut (IL); Phil WORTHINGTON, New York, NY (US); Kevin HSIEH, New York, NY (US)

(21) Appl. No.: 19/468,538

(22) Filed: Feb. 3, 2026

Related U.S. Application Data
(60) Provisional application No. 63/753,196, filed on Feb. 3, 2025.
(60) Provisional application No. 63/753,714, filed on Feb. 4, 2025.

(51) Int. Cl. G06V 20/70; G06V 20/40; H04L 51/02

(52) U.S. Cl. CPC G06V 20/70; G06V 20/41; G06V 20/47; H04L 51/02

(57) ABSTRACT

A system and method for providing access to content information of a video is disclosed which includes detecting a set of scenes from the video and detecting one or more shots for each scene of the set of scenes. The system and method then analyze the scenes and shots by using a machine learning model which returns a text description of the analyzed shots and scenes. The system and method then stores the text descriptions of the shots and scenes respectively as shot moments and scene moments in a database. The system and method also combines the scene moments by the machine learning model into a global moment configured to provide an overall context of the video and stores the global moment with the shot moments and the scene moments in the database.

### CROSS-REFERENCE TO RELATED APPLICATIONS

This patent application claims priority to and the benefit of U.S. Provisional Patent Application No. 63/753,196, filed Feb. 3, 2025, and U.S. Provisional Patent Application No. 63/753,714, filed Feb. 4, 2025, both of which are incorporated herein by reference in their entirety.

### COPYRIGHT NOTICE

A portion of the disclosure of this patent document contains material that is subject to copyright protection. The copyright owner has no objection to the facsimile reproduction by anyone of the patent document or the patent disclosure after the patent has been duly issued or the application published, as it appears in the PTO patent files or records, but otherwise reserves all copyright rights whatsoever.

### TECHNICAL FIELD

The present disclosure relates to the field of managing and accessing content information from media, including audio and video.

### BACKGROUND

Known online video content repositories have little knowledge on what content customers are uploading, like the type of videos, quality of editing, purpose of videos, topics, etc. Users of online video content platforms often desire engagement with videos, such as providing suggestions and requests in comment sections, which again requires review by the content customers or the online video content platforms. Users also frequently desire summaries of the content of a video without requiring the user to watch the video in its entirety, particularly if a video is long in duration or involves complex information. Online video content repositories also rely on the content customers to describe the videos they upload to the platform.

However, these descriptions are static and require revisions and updates to descriptions, answers to frequently asked questions, search and information queries, and comments by the content customers or the online video content platforms. Static updates are time consuming, particularly for large online video content repositories that may be able to process thousands of hours of videos per day.

Currently, providing updates and information about uploaded videos typically involves either summarizing a transcript of a video, if one exists, or using a machine learning model, such as a vision-language model (VLM), to summarize or identify content within a video. However, these methods still suffer from the issues raised above as they require content customers and/or video content platforms to identify and respond to users' requests. Accordingly, there is a need for a system and method that automates the extraction, structuring, and retrieval of video content information, enabling efficient, scalable, and interactive access to video data without manual intervention by content providers.

### SUMMARY

In an aspect, a system and/or method disclosed herein may comprise, consist of, or consist essentially of the elements of the system and/or methods as described herein, as well as any additional or optional elements described herein or otherwise useful in the assembly, configuration, instructions, or use of methods or systems for providing access to content information of a video and/or any methods or systems for detecting speakers in a video and/or any methods or systems within the scope of the current disclosure.

The current disclosure solves the foregoing problems and others by providing systems and methods for providing access to content information of a video. Unlike conventional transcript-based or flat video summarization systems, the disclosed system adaptively samples video content based on information density and organizes multimodal data into hierarchical, human-interpretable moments, enabling scalable, context-aware retrieval and interaction. Aspects of the disclosure utilizes information inside videos to allow accessing video content in ways other than watching the video. Understanding the content of video opens doors to many applications, such as Q&A, search, proactive content monitoring, personalization, data driven decisions, search engine optimization (SEO), etc. In this disclosure, video information is converted into forms that allow efficient access to the video content both online and offline. The current disclosure provides a hierarchical, multimodal and sampling-based approach. In aspects of the disclosure, machine learning models such as large language models (LLMs-a type of artificial intelligence that processes and generates human language) may be used as multimodal indexers, producing hierarchical and human-interpretable moments on sampled scenes and shots of the video.

The current disclosure utilizes all sources of information in the video: Visual, Audio, text, and metadata-a ‘Multimodal’ information. Embodiments of the disclosure convert the information into Hierarchical video moments, which are sampled from the video based on the information density and stored in both vectorized and human interpretable structure, such as text. In addition, the current disclosure uses LLMs as multimodal indexers, producing Hierarchical and Human-interpretable moments on sampled scenes and shots of the Video.

As a result, videos are decomposed into accessible and expandable sources of information, which allow building applications on top of it.

At a high level, the current disclosure converts a video into a text based human interpretable database, including multiple video modalities such as speech (transcript) if available, visuals, audio. Converting the video into a human interpretable and digestible database that includes data from multiple available modalities allows for a much broader and deeper understanding of the video, and therefore a significantly better coverage of the video content.

Thus, this hierarchical video intelligence system becomes a powerful source of information that can be used for various purposes such as: enhanced search, question answering including references to the relevant areas in the video (playable references), generation of relevant follow up questions, video details generation (such as title, description, tags). In this way, the present disclosure addresses the foregoing problems by providing a hierarchical, multimodal, and sampling-based approach that leverages advanced machine learning models to generate human-interpretable representations of video content. By converting video data into structured, searchable, and context-rich textual and vectorized forms, the invention enables a range of applications-including enhanced search, interactive Q&A, and automated content monitoring—while significantly reducing the manual effort required to manage and update video metadata and descriptions

In one aspect of the disclosure, a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method for providing access to content information of a video may include detecting a set of scenes from the video. The method for providing access to content information of a video may also include detecting one or more shots for each scene of the set of scenes utilizing a sample rate that is adaptive based on one or more of, content of the video or duration of the video. The method for providing access to content information of a video may furthermore include analyzing the scenes and shots by using a machine learning model configured to return a text description of the analyzed shots and scenes. The method for providing access to content information of a video may in addition include storing the text descriptions of the shots and scenes respectively as shot moments and scene moments in a database. The method for providing access to content information of a video may moreover include combining the scene moments by the machine learning model into a global moment configured to provide an overall context of the video. The method for providing access to content information of a video may also include storing the global moment with the shot moments and the scene moments in the database in a hierarchical structure. The method may also include shot moments stored in a first lower level of the hierarchical structure, the global moments are stored in a third a higher level of the hierarchical structure and the scene moments are stored in a second mid-level of the hierarchical structure between the first lower level and the third higher level. Other embodiments of this aspect include corresponding computer systems, apparatus, and computer programs recorded on one or more computer storage devices, each configured to perform the actions of the methods.

Implementations may include one or more of the following features. The method where the storing steps include registering the shot moments, scene moments and global moment into a vector database. The method where the registering uses multi-modal video retrieval augmented generation (RAG) architecture. The method may include identifying names associated with speakers in the video. The method may include retrieving data associated with the video using semantic searching. The method may include retrieving data associated with the video using a question and answer application. The method where the question and answer application populates a chatbot with several pre-generated questions and answers.

The method where the pre-generated questions and answers are generated during the registering step by using a machine learning model to generate question-answer pairs from the shot moments, scene moments and/or global moment. The method where retrieval augmented generation (RAG) architecture is also used to create chat answers that are saved in the vector database. The method may include querying the vector database for widening the chat conversation based on the original question-answer pair.

The method where a machine learning model is used to create questions related to the pre-generated questions, where the related questions have one or more of the following characteristics: the related question is related to the topic of the original viewer question; the related question is not already presented in the chat answer; and/or the related question can be answered from the given retrieved content. The method where each of the scenes have a length of time equal to or greater than a threshold time length. The method further may include determining a length of time for each of the detected scenes prior to analyzing the scenes by the machine learning model; if the length of time of the detected scene is less than the threshold time length, combine the detected scene with a next proceeding detected scene until the scene has a length of time equal to or greater than the threshold time length; and if the length of time of the detected scene is equal to or greater than the threshold time length, proceed to analyze the scene by the machine learning model. In aspects, the threshold time length is a fixed time threshold.

In aspects, the threshold time length is a percentage time threshold.

The method may include dividing a transcript of the video into transcript segments associated with each of the scenes and/or each of the shots. The method may include content of the video determined based on the presence of static content versus the presence of dynamic content. A method for detecting speakers in a video using any of the above described methods. The method where shots are detected using changes in sampling rates within scene. A system for providing access to content information of a video, comprising: a processor configured to perform any of the above methods A method for detecting speakers in a video using any of the above methods. The system for providing access to content information of a video may include a vector database and one or more machine learning models. The system may include one or more computing systems configured to: detect a set of scenes from a video; detect one or more shots for each scene of the set of scenes utilizing a sample rate that is adaptive based on one or more of, content of the video or duration of the video; analyze the scenes and shots by using the least one machine learning model configured to generate a textual description of the analyzed shots and scenes; store the textual descriptions of the shots and scenes respectively as shot moments and scene moments in the vector database; generate, based on the scene moments or the shot moments, a global moment configured to provide an overall context of the video; and store the global moment with the shot moments and the scene moments in the vector database in a hierarchical structure. In this aspect, the shot moments may be stored in a first lower level of the hierarchical structure, the global moments are stored in a third a higher level of the hierarchical structure and the scene moments are stored in a second mid-level of the hierarchical structure between the first lower level and the third higher level.

One or more non-transitory memories including computer instructions for instructing one or more processors to perform any of the method of the above. One or more non-transitory memories including computer instructions for instructing one or more processors to perform the steps comprising: detecting a set of scenes from the video; detecting one or more shots for each scene of the set of scenes utilizing a sample rate that is adaptive based on one or more of, content of the video or duration of the video; analyzing the scenes and shots to generate a textual description of the analyzed shots and scenes; storing the textual descriptions of the shots and scenes respectively as shot moments and scene moments in a database; generating, based on the scene moments or the shot moments, a global moment configured to provide an overall context of the video; and storing the global moment with the shot moments and the scene moments in the database in a hierarchical structure. In this aspect, the shot moments may be stored in a first lower level of the hierarchical structure, the global moments are stored in a third a higher level of the hierarchical structure and the scene moments may be stored in a second mid-level of the hierarchical structure between the first lower level and the third higher level.

The method where speaker detection includes the following steps where speaker detection includes the following steps: clustering an audio portion of the video into sets of different speakers, each having a speaker ID, and labeling each sentence in the transcript with a corresponding speaker ID; identify transitions in the transcript where a handover of conversation occurs between different speakers; for every transition, using a machine learning model to identify speaker names by analyzing each side of the each transition and masking one or more speaker names based on the prompt type; for each identified speaker name, counting a number of transitions attributed to the speaker; and using the counts, removing with the assistance of a decision function potential identification errors that are not established with a predetermined confidence level.

The method may include rendering, in a display of a user device, a graphical user interface comprising a video pane and a context pane, wherein the video pane displays a user selected video, obtaining, from the database, the shot moments, the scene moments, and the global moment corresponding to the user selected video. Further, the method may render, in the context pane at least one of: (i) at least one selectable playable moment corresponding to a respective scene moment or a respective shot moment, (ii) a user query input field; and (iii) a user query output field. The method may include receiving a user query via the user query input field; retrieving from the database, based on the user query, one or more relevant moments from among the shot moments, the scene moments, and the global moment of the user selected video; and rendering textual content derived from the relevant moments in the user query output field or at least one selectable playable moment corresponding to a moment related to the results responsive to the user query. In aspects, retrieval augmented generation (RAG) architecture may be used in the retrieving and rendering steps. Implementations of the described techniques may include hardware, a method or process, or a computer tangible medium.

In another aspect, a method for providing access to content information of a video may include detecting a set of scenes from the video; detecting one or more shots for each scene of the set of scenes; analyzing the one or more shots for each scene by using a machine learning model configured to return a text description of the analyzed shots; storing the text descriptions of the analyzed shots as shot moments for each scene of the set of scenes in a database; combining the shot moment for each scene of the set of scenes by the machine learning model into scene moments for each scene of the set of scenes; combining the scene moments by the machine learning model into a global moment configured to provide an overall context of the video; and storing the global moment in the database. Other embodiments of this aspect include corresponding computer systems, apparatus, and computer programs recorded on one or more computer storage devices, each configured to perform the actions of the methods.

### BRIEF DESCRIPTION OF THE DRAWINGS

FIG. 1 illustrates an aspect of a method for providing access to content information of a video according to the disclosure.

FIG. 2 illustrates an aspect of a moment the hierarchical video intelligence system according to the disclosure.

FIG. 3 illustrates an aspect of a method for providing access to content information of a video using shot and scene moments according to the disclosure.

FIG. 4 illustrates an aspect of a method for providing access to content information of a video using, shot, scene, and transcript moments according to the disclosure.

FIG. 5 illustrates an aspect of the architecture of the hierarchical video intelligence system according to the disclosure.

FIG. 6 illustrates an aspect of a system and method for providing access to content information of a video using Video-RAG according to the disclosure.

FIG. 7 illustrates an aspect of a method for providing access to content information of a video using a video transcript according to the disclosure.

FIG. 8 illustrates an aspect of a method for providing access to content information of a video using a prompt according to the disclosure.

FIG. 9 illustrates an aspect of a method for providing access to content information of a video using a prompt according to the disclosure.

FIG. 10 illustrates an aspect of a method for providing access to content information of a video using a prompt according to the disclosure.

FIG. 11 illustrates an aspect of a method for providing access to content information of a video using a prompt according to the disclosure.

FIG. 12 illustrates an aspect of a method for providing access to content information of a video using a prompt according to the disclosure.

FIG. 13 illustrates an aspect of a method for providing access to content information of a video using a prompt according to the disclosure.

FIG. 14 illustrates an aspect of a method for providing access to content information of a video using a prompt according to the disclosure.

FIG. 15 illustrates an aspect of a method for providing access to content information of a video using a prompt according to the disclosure.

FIG. 16 illustrates an aspect of a method for providing access to content information of a video using speech diarization according to the disclosure.

FIG. 17 illustrates an aspect of a method for providing access to content information of a video using playable moments according to the disclosure.

FIG. 18 illustrates an aspect of a method for providing access to content information of a video using pre-generated questions according to the disclosure.

FIG. 19 illustrates an aspect of a method for providing access to content information of a video using related questions according to the disclosure.

### DETAILED DESCRIPTION

The present disclosure provides exemplary system(s), pipeline(s) and process(es) that allows effective video analysis using the capabilities of advanced machine learning models. Many videos have redundant information and not all videos need to be sampled in the same way. An embodiment of the present disclosure thus provides a system which may be sampled based on the content, such as by considering how frequently the visual content is changing drastically. For panel discussions, or slide presentations, videos would not require a lot of scenes or shots, but for commercials it would. An embodiment of the present disclosure may also provide a system which may be sampled based on the length of the video. Shorter videos may need to be sampled at a higher rate than longer videos. As such, an embodiment of the present disclosure may provide a system which is capable of processing 2 million minutes of video per day.

An embodiment of the present disclosure also provides a system for implementing machine learning models which can be used as indexers to understand the content in the sub video chunk, and transform it into a canonical form that will be stored for further retrieval and applications. For example, a multimodal LLM may be used to extract information from frames and audio shots and transform them into a textual form, describing what is in this specific shot. The textual information may be saved with the rest of the representations (embeddings) and allow simple retrieval, rather than only embedding based retrieval which has limited abilities.

An embodiment of the present disclosure also provides a system, where data is structured in a hierarchy. Videos contain information that span across variable time scales, some information is localized and some is spread across distance in time frame, video moments are structured in hierarchical manner to allow capturing higher level concepts spanned across larger time scales as the moment is composed of multiple localized moments.

An embodiment of the present disclosure also provides a system to identify speaker names, using unstructured formats, based on transcript and speech diarization. The system also may infer the name from clues in the text itself and the conversation.

Embodiments of the current disclosure may rely on an architecture that is called RAG, or retrieval augmented generation. The novelty of RAG lies in its ability to integrate context from a specific domain or dataset into machine learning model, such as LLMs, which the LLM wouldn not have knowledge of otherwise.

RAG has several important advantages over using only a standard LLM. It reduces the chance of generating hallucinated responses, because the answer is grounded in the context provided to the LLM. Moreover, providing specific context to an LLM is especially important for business use cases or when dealing with private user data or knowledge bases. An example of the former can be a customer support bot, where an example of the latter can be extracting information from medical reports.

Another advantage of RAG is the effective retrieval of information from large textual databases. Large textual databases would be required to feed the full text to the LLM in order to provide it with the required information for a question that may only be relevant to a small portion of that database. With RAG, it is possible to organize information such that only small parts of relevant context would be retrieved and used by the LLM to provide the final answer, preventing bias, improving accuracy, cost and latency.

RAG is especially useful when solving the problem of answering questions on specific textual databases. To achieve this, the text is first split into small chunks, and then each chunk is embedded and stored into a vector database. When the chatbot receives a question from a user, the question is first converted into a vector embedding and then queried against the vector database to get the best matches by a nearest neighbors search. Finally, the matches form a context for the LLM, which uses it to generate an answer to the question. So the retrieval component of RAG means retrieving the context from the vector database, which is then augmented to the LLM for the generation component.

In another embodiment, embeddings are stored together with text and tags enabling hybrid searching capabilities. In such an embodiment, searching may extend beyond the embeddings.

RAG is typically used to process documents, but in principle any data that can be transformed into text can be processed by RAG. For example, the audio track of a video file can be transcribed into a text file of what is said, and an image can be represented by a textual description of the visual information that the image contains.

An embodiment of the present disclosure also provides a system that accounts for a wide variety of inputs that can be received, and anticipates the most common types of inputs. Several question types are common:

General. Questions about what's happening in the video in general or asking to summarize the video as a whole or specific topics in it.

Speakers. Questions about the speakers in the video or about what a specific speaker is saying.

Specific details. Questions about specific details mentioned in the video or wanting to navigate to a specific part of the video.

Answering the first two types of questions typically requires using large portions of the video or perhaps even the entire video, while answering the third type of question typically requires a small portion of the video, maybe just a couple sentences that contain the requested detail. This gives rise to the need of representing the video in some hierarchical way of both short and long context in order to meet these different needs of different questions.

However, there are many other videos where there are other important modalities such as visuals, actions and music. In an analysis, it was observed that for 50% of the marketing videos that are uploaded to Vimeo have no speech at all and the visual and music modalities are the dominant ones. Moreover, in knowledge-sharing videos, the visual modality may be important and complementary to the speech modality in the form of slides or written speaker names when those are presented.

Thus, an embodiment of the present disclosure also provides a system and method of implementing video-RAG which is multi-modal in its core, called H\hat{ }3 Video Intelligence, represents the video by High-level Human-interpretable Hierarchical moments. Each moment represents a certain part of the video (between times t1 and t2) by a rich textual description that is generated by a multi-modal LLM. The moments are stored in a vector database by using a standard textual embedding.

This method has several improvements over using specialized video embeddings and enables natural integration to many different modalities, such as speech transcript, actions and music in one simple framework. It also supports moments of very different durations-from very localized video shots or speech sentences up to the entire context of the video.

The video parts are built in a hierarchical fashion where scenes are first detected in the video by audio-visual clustering (for example audio diarization of the speakers in the video). Then for each scene, shots are extracted by detecting video cuts or transitions. The next step is to generate shot moments for each video shot and combine each group of shots and its corresponding speech transcript (if that exists) to generate scene moments. Finally, all the scene moments are taken and combined to get global moments in the form of a video summary, video description, video title and video social hashtags.

H\hat{ }3 Video Intelligence enables the video-RAG Q&A system to deal with a wide range of questions-such as very specific details, localized in the video, but also very general details about the video purpose and video storytelling. Questions may involve specific modalities such as speech or vision, but also may be such that involve a combination of several modalities. For example, the system may be applied to videos, where speaker diarization is used to segment scenes by speaker, and the resulting moments enable users to search for specific topics or speakers. In another embodiment, the system may be able to process videos without speech, relying on visual and audio cues to generate moments. The system can also handle multilingual videos by integrating language localization.

Further, a classical approach that is common in machine learning is called bottom-up processing. It originates from cognitive science. The idea is that, when processing a signal, operations are performed iteratively from a bottom layer of representation to higher levels of representation that have a larger semantic meaning. The bottom levels are obtained using operations with a small context window, whereas the higher levels are obtained using larger context windows. This is achieved by merging and processing neighboring results-in other words, grouping results that are close in time or space-to obtain a new level of representation. In this way, at each level of analysis, an embodiment effectively enlarges the size of the context window.

A good example of a bottom-up network is convolution neural networks (CNN) in computer vision. The current disclosed approach resembles taking a CNN with only a few layers and replacing the convolution operator by an LLM. The first layer processes local temporal information (shots), then these are merged to larger temporal context with larger semantic meaning (scenes) and at the final layer a global semantic information of the entire video is obtained. In a typical CNN after each layer a vector representation of some part of the image is obtained and the last layer is a vector representation of the entire image. In the current disclosure instead of vectors, textual descriptions are obtained.

Various aspects of the disclosure may be utilized on a user computing device, which may be any type of computing device, e.g., laptop, smartphone, mobile telephone, cellular telephone, tablet computer, etc., which may be configured to transmit and/or receive data to and/or from a remote computing platform. The user computing device may include wired connections, such as a serial or parallel bus, Ethernet, optical connections, or other type of wired connection. The user computing device may also use communication links such as wireless links, such as Bluetooth, IEEE 802.11 (IEEE 802.11 may refer to IEEE 802.11-20010, IEEE 802.11n-2009, or any other IEEE 802.11 revision), CDMA, 3G, GSM, WiMAX, or other wireless based data communication links. The remote computing platform may include the vector database configured to store the moments described herein and may host via a server the hierarchical video intelligence system, various applications and methods described herein.

The user computing device and remote computing platform may include various components including, but are not limited to, one or more processors or processing units, a system memory for storing the instructions for implementing the methods described herein, and a bus that couples various system components including system memory to the processor. The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (‘ISA’) bus, Micro Channel Architecture (‘MCA’) bus, Enhanced ISA (‘EISA’) bus, Video Electronics Standards Association (‘VESA’) local bus, and Peripheral Component Interconnects (‘PCI’) bus.

In other examples, the user computing device may be configured to communicate with remote computing platform via wireless access points. Access points may take various forms. For example, an access point may take the form of a wireless access point (WAP) or wireless router. As another example, if a client device connects using a cellular air-interface protocol, such as CDMA, GSM, 3G, or 4G, an access point may be a base station in a cellular network that provides Internet connectivity via the cellular network.

As such, the user computing device and/or the remote computing platform may include a wired or wireless network interface through which the user computing device 1100 may connect to remote computing platform directly or via access points. As an example, the mobile computing device may be configured to use one or more protocols such as 802.11, 802.16 (WiMAX), LTE, GSM, GPRS, CDMA, EV-DO, and/or HSPDA, among others. Furthermore, the mobile computing device 1100 may be configured to use multiple wired and/or wireless protocols, such as “3G” or “4G” data connectivity using a cellular communication protocol, e.g., CDMA, GSM, or WiMAX, as well as for “Wi-Fi” connectivity using 802.11. Other types of communications interfaces and protocols could be used as well.

The user computing device may also include a graphical user interface (GUI) as described herein. The user computing device may include a display screen and input devices to interact with the GUI. For example, the input devices may include, but are not limited to mouses, buttons, touch screens, keyboards, stylus digitizers, etc.

All of the above, are together composing a flow which when combined as a system provides a unique type of video understanding, which have not been seen elsewhere. Thus, unlike conventional systems that rely solely on transcript-based summarization or static metadata, the present disclosure integrates multimodal data (visual, audio, text, metadata) and organizes it hierarchically, enabling more accurate, context-aware, and interactive access to video content.

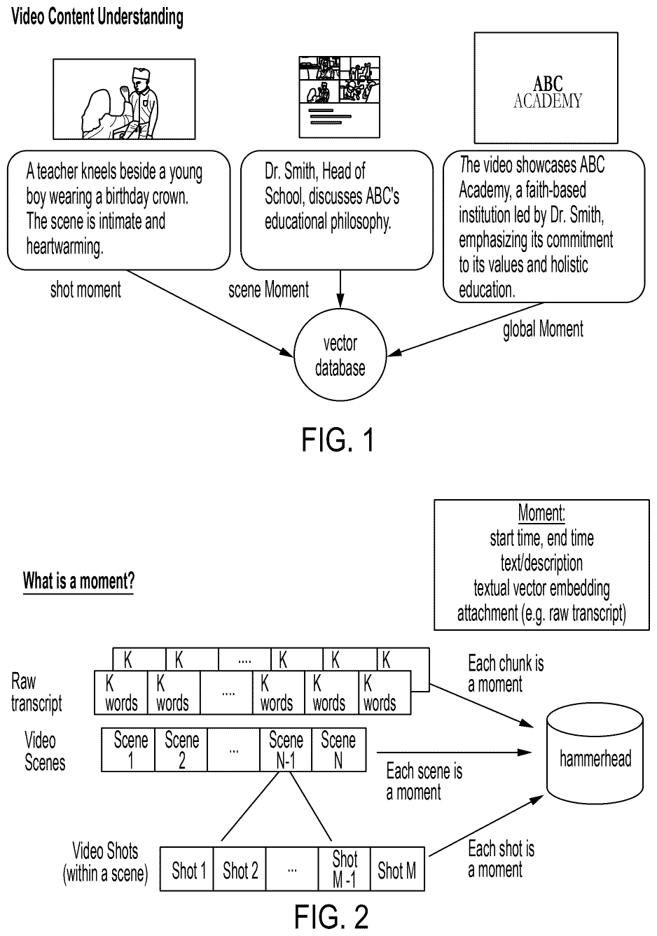

As shown in FIG. 1, in an embodiment, the disclosure involves creating hierarchical textual moments. A “moment” for the purpose of this disclosure is a piece of video, audio, or textual data that is stored in a database as a textual description and/or a vector representative of the textual description to enable a machine learning model to engage with the moments using natural language processing. That is, a moment may be stored in a database as text and/or a numerical representation (i.e., vector) of the text to enable semantic, similarity, and search analysis. Thus, in embodiments of the disclosure, a moment may include a structured data object representing a bounded temporal segment of video and includes at least: (i) a textual description, and (ii) a temporal reference. Optional attributes include embeddings, tags, modality indicators, and attachments. A moment may also include any derivative or extension of the video data (such as transcript, translation, written text within the video frames, detections, summarizations, etc.) that is stored in the database as a textual description (and/or stored as vectorized, tagged or any other form that allows searchability on the piece of video data)

Examples of moments include, but are not limited to, shot moments that capture small details in the video, scene moments representative of a video segment, and zoomed out global moments to get the broader understanding of the entire video content, which may be stored in a vector database. A moment may also include a transcript for the audio portion of the video if a transcript of the video exists. Each moment may include a textual description along with other metadata or attributes including start time-stamps and end time-stamps associated with the moment, a textual vector embedding that represents the texts and enables searching, and/or an attachment (e.g., raw text, transcript, audio, and/or visual data).

FIG. 2 illustrates another aspect of the disclosure including moments stored within a database. For example, a video may be segmented into a plurality of N scenes (N being a positive integer) depending on the length and complexity of the video. A scene may be a segment of a video, such as when a speaker changes, and/or a visual cut or transition occurs.

For each of the N scenes, a moment may be generated and stored in a database. Each of the N scenes may also be segmented into a plurality of M shots (M being a positive integer) depending on the length and complexity of the N scenes. That is, a shot may be a sub-segment of a scene, including at least 1 frame or a continuous sequence of a plurality of frames. For each of the M shots, a moment may be generated and stored in a database. A transcript of the video may also be segmented into a plurality of transcript sections made of K words corresponding substantially with each of the N scenes and/or each of the M shots and stored as a moment, since the transcript is already a textual description, and stored in a database. The database may be any database capable of indexing and recalling textual descriptions and may include similarity search capabilities, such as a vector database. Shot moments may be stored in a first lower level of the hierarchical structure, the global moments may be stored in a third a higher level of the hierarchical structure and the scene moments may be stored in a second mid-level of the hierarchical structure between the first lower level and the third higher level for indexing and recalling in a vector database. When using a vector database each of the moments are stored as a vector embedding generated by a machine learning model.

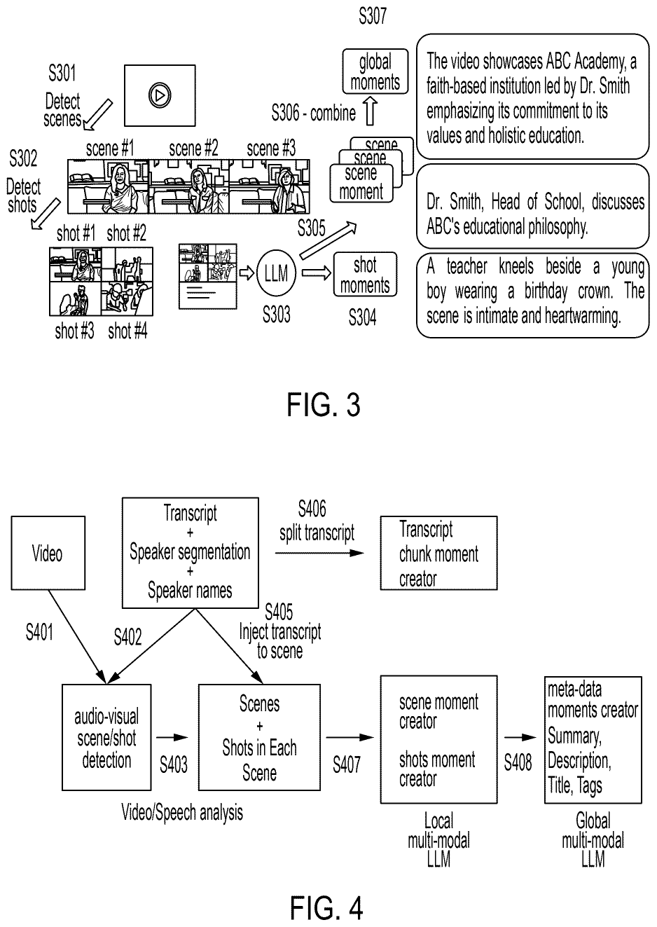

FIG. 3 illustrates an embodiment of the disclosure of a system implementing a method for providing access to content information of a video. The hierarchical video intelligence system may include analyzing the video to detect scenes and shots of the video and then create shot moments, scene moments, and global moments using a machine learning model, such as an LLM, in a hierarchical manner from the bottom-up. In this way, the hierarchical video intelligence system may create shot moments, scene moments, and global moments in a parallel and iterative fashion rather than simultaneously, thereby speeding up video processing. The hierarchical video intelligence system may include taking a video comprising a set of N scenes, where Nis a positive integer, and detecting each scene of the set from the video at S301. Scenes may represent different portions of the video based on specific speakers or between different narratives.

Thus, the hierarchical video intelligence system may be configured to create scenes and scene moments to prevent repetitive information, mixed information, and can create feature vectors as scene moments to provide additional context when implementing Video-RAG as described herein. Each moment is then made in a more meaningful way and gives each scene it owns place rather than missing a portion of the video when summarizing. This process is also easier for the machine learning model to identify the speaker(s) associated with each scene and/or shots of the video. The scenes may be detected by using speech diarization, video cuts, and/or video transitions as described herein.

For example, the hierarchical video intelligence system may detect each of the scenes by using speech diarization by checking each video segment with a different speaker to see if the video segment is long enough relative to the length of the video. If the each of the video segments with different speakers is long enough, the hierarchical video intelligence system designates each video segment as a detected scene.

If video segments with different speakers are not long enough, such as during a dynamic conversation between people, several video segments containing different speakers are merged together until a desired video length is made. For example, a threshold time length may be designated by the hierarchical video intelligence system that may or may not be dependent on the length of the video. For example, the threshold time length may be a fixed time threshold to be, for example 1 minute, 2 minutes, or 3 minutes and if a given video segment is not equal to or longer than the fixed time threshold, the hierarchical video intelligence system may merge sequential video segments together until the fixed time threshold is met. The threshold time length may be a percentage threshold to be 5%, 10%, 20% of the total time. For example, a video may have a total length of 10 minutes and a percentage threshold chosen to be 10%. If a given video segment is not equal to or longer than 1 minute, the hierarchical video intelligence system may merge sequential video segments together until the percentage threshold is met. This system and method of detecting scenes via speech diarization is useful in settings where there are multiple speakers where each speaker is given a time to talk (e.g., lectures, interviews, testimonials, etc.). In other cases, this system ensures a given scene will end at the end of a certain speaker segment. For very long speaker segments, such as 5 minutes, 10 minutes, 20 minutes, the video segment may split into several segments and identified as individual scenes in order to ensure the segment will get more moments and attention when summarizing the video.

In another aspect, video cuts and/or video transitions may be utilized by the hierarchical video intelligence system to detect scenes. Video cuts may include any video cut known to those skilled in the art which indicate an abrupt change between frames in a video including, but not limited to, straight cuts, jump cut, match cuts, cutaways, cross-cuts, smash cuts, invisible cuts, J-cuts, L-cuts, and montages. Video transitions may include any video transition or effect known to those skilled in the art which indicate a gradual change between frames in a video (e.g, over 1 or 2 seconds) including, but not limited to, a dissolve transition, fade in, fade out, wipe transition, whip pan, and a masking or overlay transition. Video cuts and/or video transitions may be utilized by the hierarchical video intelligence system to detect scenes in conjunction with speech diarization or individually. Video cuts and/or video transitions may be utilized by the hierarchical video intelligence system to detect scenes if there is no speech or no available speaker diarization for a video and/or a particular video segment. Then several shots are aggregated together as a called shot such that the scene will be spread quite uniformly across the video.

After detecting each scene of the set of N scenes, the hierarchical video intelligence system may detect M shots, where M is a positive integer at S302. The detecting of the shot may be based on video cuts and/or transitions. For example, a last shot for one scene may be detected by using a frame on one side of a video cut or a video transition and a first shot for the next subsequent scene may be detected by using a frame on the other side of a video cut or a video transition.

The shots may be detected by separating each scene into frames based on an adaptive frame rate, where each frame corresponds to a shot. The adaptive frame rate may be a frame rate based on the content of the video. For example, the adaptive frame rate may be 1 frame per second (i.e., detecting 1 shot per second) when the video contains sports content, or action content or 1 frame per 30 seconds (i.e., detecting 1 shot per 30 seconds) when the video contains largely static content (e.g., slide presentation). The adaptive frame rate may be based on the duration of the video. For example, in a short video of less than 5 minutes, the adaptive frame rate may be 5 frames per second, and for a long video, the adaptive frame rate may be 1 frame per minute.

The shots may be detected by separating each scene into frames based on an adaptive sample rate, where each frame corresponds to a shot. The adaptive sample rate may be a sample rate based on the content of the video. For example, if the video includes static content, such as a recorded meeting including a slide presentation, the sample rate may be low, such as 5 shots per scene where each scene is representative of a single slide. In comparison, if the video includes dynamic content such as a marketing video with quick scene cuts, the sample rate may be high, such as 20 shots per scene. The adaptive sample rate may also be based on the video duration, where shorter videos have a higher shot sampling rate and longer videos have a lower shot sampling rate. For example, a video that is 4 minutes long may have 4 scenes with 30 shots per scene and a video that is 8 minutes long may have 8 scenes with 15 shots per scene.

For a video scene which has a lot of changing visual content many shots may be obtained and if the visual variance is small a few shots (e.g. several static slides) may be obtained. To ensure too many shots are not obtained for long videos, long videos may be sampled at a low sample rate (e.g every 3-6 seconds). In an embodiment of the disclosure, a video of 90 minutes with a lot of visual variation and speakers, sampling yielded 40 scenes and a total of 300 shots. In a 45 minutes meeting video, with less variation and speakers, 13 scenes were obtained and only 60 shots. For a short video which is very dynamic, it was sampled at a high frame rate, so 11 scenes and 50 shots were obtained. A short 5-minute video of a single talking head may get only 10 scenes and 10 shots.

This is the meaning of being adaptive in the sampling and/or frame rate. Detecting shots of scenes in an adaptive manner may also provide significant cost savings. In other words, The hierarchical video intelligence system adapts the sampling and/or frame rate based on video content and duration, using higher rates for dynamic or short videos and lower rates for static or long videos, thereby optimizing processing efficiency and cost. For example, for an hour of video with 90 sampled frames/shots a price reduction of a factor of 40 (i.e., 3600 seconds/90 shots) may be obtained as compared to using a sample rate of 1 second per shot with the entire video with 3600 seconds as input.

After the scenes and their associated shots are detected at S301 and S302, the hierarchical video intelligence system may analyze the scenes and shots by using a machine learning model configured to return textual description (i.e., a moment) for each of the respective scenes and shots at S303. The machine learning model could be any machine learning model capable of turning visual information into vector embeddings including an LLM, a multi-modal LLM, a vision-language model (VLM), or an end-to-end embedding model (E2E). At S304, the hierarchical video intelligence system stores the shot moments in a database, such as a vector database. As such, the hierarchical video intelligence system may utilize an LLM, a multi-modal LLM, a vision-language model (VLM), or an end-to-end embedding model (E2E) to generate textual descriptions from video, audio, and transcript data. These descriptions may be embedded using a standard textual embedding (or tags) model and stored in a vector database, enabling efficient semantic search and retrieval or filtering. At S305, the hierarchical video intelligence system stores the scene moments in a database.

At S306, the hierarchical video intelligence system may combine the scene moments by inputting the scene moments as part of a prompt of the machine learning model to create a global moment configured to provide an overall context of the video. At S307, the hierarchical video intelligence system may store the global moment with the shot moments and the scene moments in the database. In another embodiment, at S306, the hierarchical video intelligence system may combine the scene moments and the shot moments by inputting the scene moments and the shot moments as part of a prompt of the machine learning model to create a global moment configured to provide an overall context of the video. Thus, in one example, a 60-minute panel discussion video may be processed by the hierarchical video intelligence system into 12 scenes and 60 shots, where each of the 12 scenes includes 5 shots, and the hierarchical video intelligence system may generate 12 corresponding scene moments, 60 corresponding shot moments, and 1 global moment for the 60-minute video to store in the database.

FIG. 4 illustrates another aspect of the disclosure of a system implementing a method for providing access to content information of a video. The hierarchical video intelligence system may include taking a video at comprising a set of scenes and detecting each scene of the set from the video at S401 and a transcript and its metadata at S402 and sending the video and the transcript to a video and speech analysis module. The video and speech analysis module may then detect shots for each scene at S403. For example, the scenes may be detected by using speech diarization, video cuts, and/or video transitions as described herein and the shots may be detected by separating each scene into frames based on a desired frame rate or based on a desired sample rate as described herein. The scenes may also be detected by injecting the transcript at S405 and using speech diarization depending on speaker names and/or speaker segmentation as described herein. At S406, the hierarchical video intelligence system may analyze a transcript of the video by separating the transcript into segments of text as moments corresponding to each of the respective scenes and/or shots.

After the scenes and their associated shots are detected, the hierarchical video intelligence system may analyze the scenes and shots by using a first local machine learning model configured to return a textual description (i.e., a moment) for each of the respective scenes and shots (as well as tags and detections if available) at S407. The machine learning model could be any machine learning model capable of turning visual information usable with a vector database including an LLM, a multi-modal LLM, a VLM, or an E2E model. In the context of an LLM, a multi-modal LLM, and a VLM, the hierarchical video intelligence system first turns the visual information into text and then creates embeddings to store in the vector database. In contrast, an E2E model may be used which would enable the visual information to be generated as feature vector embeddings without first creating text.

At S408, the hierarchical video intelligence system may combine the scene moments by inputting the scene moments as part of a prompt of a second global machine learning model to create a global moment configured to provide an overall context of the video and include other important metadata (e.g., start and end time stamps, attachments, etc.) associated with the global, scene, and shot moments. In another embodiment, at S408, the hierarchical video intelligence system may combine the scene moments and the shot moments by inputting the scene moments and the shot moments as part of a prompt of the machine learning model to create a global moment configured to provide an overall context of the video. The hierarchical video intelligence system may then store the transcript, global, scene, and shot moments in a database.

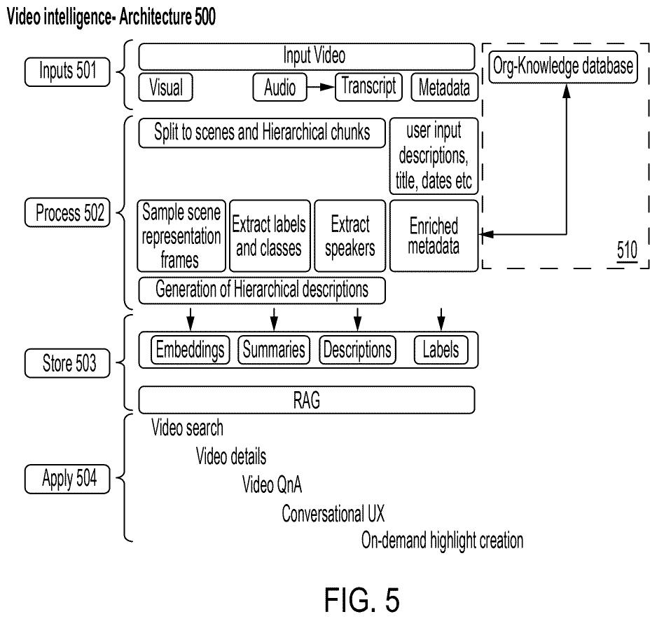

FIG. 5 illustrates an aspect of the disclosure describing a hierarchical video intelligence system architecture for providing access to content information of a video. The hierarchical video intelligence system may receive a video input, which may include visual, audio, and metadata components. A video processor may analyze the input to detect scenes and shots, segments transcripts, and extracts relevant features. Machine learning models, such as multi-modal LLMs or vision-language models, are then used to generate shot moments, scene moments, and global moments, which are stored in a vector database. This architecture supports rapid semantic search and retrieval, as well as integration with user-facing applications such as chatbots and content monitoring tools.

For example, the hierarchical video intelligence system 500 may include a variety of inputs 501 such as an input video to convert and process into a vectorized format. The input video may include a visual component, an audio component, and metadata. The audio component may also be converted into a transcript to be included as an additional input for the hierarchical video intelligence system. The hierarchical video intelligence system 500 may include a video processor 502 for performing aspects of the disclosure described herein, such as those described in the FIGS. 3 and 4. For example, the video processor 502 may analyze the video to detect the scenes and the shots, separate the transcript into segment chunks to correspond to the scenes and/or shots, extract labels and classes, extract speakers, receive and process various user inputs, send and retrieve data from an organization's knowledge database 510, and generate the shot, scene, and global moments.

The hierarchical video intelligence system 500 may include a memory coupled to the processor 502. The memory may contain executable instructions that, when executed by processor 502, cause processor 502 to effectuate operations associated with the methods of various aspects described herein, such as those described in the FIGS. 3 and 4. The memory may be a non-transitory computer readable medium including any tangible storage and/or transmission medium that participates in providing instructions to the processor 502 for execution. Such a medium may take many forms, including but not limited to, non-volatile media, volatile media, and transmission media (e.g., cloud storage). Non-volatile media includes, for example, non-volatile random access memory (NVRAM), or magnetic or optical disks. Volatile media includes dynamic memory, such as main memory. Common forms of computer-readable media include, for example, a random access memory (RAM), a programmable read only memory (PROM), and erasable programmable read only memory EPROM, a FLASH-EPROM, a solid state medium like a memory card, any other memory chip or cartridge, or any other medium from which a computer can read.

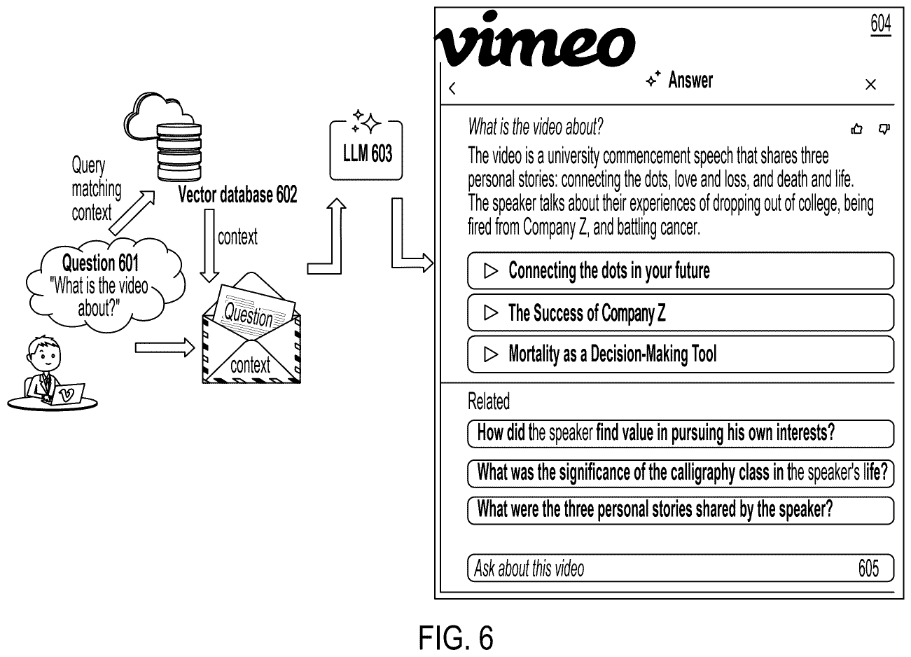

The hierarchical video intelligence system 500 may include a store 503, such as a vector database. The processor 502 may be configured to register the generated video moments (i.e., shot, scene, global, metadata, and transcript moments) into the store 503 using multi-modal Video-Retrieval Augmented Generation (RAG). RAG is an architecture used to effectively retrieve semantically relevant data from a large textual database, such as described in FIG. 6. The hierarchical video data from all modalities may be registered into the store 503 in small textual chunks (moments) and then converted into a vector database by using a standard textual embedding. Once the video data is registered into the store 503, both the moments and their vectoral representation can be quickly retrieved utilizing the vector embeddings for a quick semantic search and using the matching textual representation as a context to our question answering application. An additional step may include identifying the name associated with each speaker ID as referred within the video itself (for example verbally introducing a person).

The hierarchical video intelligence system 500 may include various applications 504 with instructions stored in the memory coupled to processor 502. The applications 504 may be executed by processor 502 or by a separate application processor via an application programming interface (API).

In certain aspects of the disclosure, an application 504 may include an Ask-AI tool that allows viewers to ask questions about the video via a graphical user interface (GUI) connected to the hierarchical video intelligence system 500. The Ask-AI tool may be built on top of the Video-RAG architecture and tailored for video-based question answering. This application is able to not only find the right answer in the video but also point out the specific time frame for the answer to appear in the video, moreover it is generating initial conversation starting questions and/or follow up questions that one may ask with respect to the previous question. Further, for each answer, it provides the specific video timing or link to where in the video the answer appears.

In another aspect of the disclosure, an application 504 may include a Library Search function which allows a user via a GUI to answer questions about the library, taking into account cross organization information like company goals and specific employees search appearance. This application brings the static content in libraries to live.

In another aspect of the disclosure, an application 504 may include proactive content monitoring where pre-processed video information is able to provide visibility to the video content and can allow setting up an artificial intelligence (AI) agent to track specific types of content, link them to rules and make alerts. For instance, tracking that sensitive information will not leak due to poorly set up privacy settings of a video with sensitive data.

In another aspect of the disclosure, an application 504 may include data-driven decisions where Business Intelligence analytics can track users with specific types of content and provide them with tailored tools, as well as the next feature decision can ask an embodiment of the current disclosure (referred to herein as Video Intelligence Service or VIS) to report the amount of videos with content X or Y.

In another aspect of the disclosure, an application 504 may include search engine optimization (SEO) which introduces the ability to adjust metadata to any style, as well as to optimize for SEO. Videos can be better discoverable by using properly set SEOs based on content in the video.

In another aspect of the disclosure, an application 504 may include language localization to allow users to interact with the video content in any language by integrating language localization.

FIG. 6 illustrates a system implementing Video-RAG according to various aspects of the disclosure. When the hierarchical video intelligence system receives a query from the user 601, the hierarchical video intelligence system retrieves the relevant context from a vector database 602 including the shot, scene, global, transcript, and metadata moments of a video. To do this, the hierarchical video intelligence system first uses a machine learning model, such as an LLM, to generate a feature vector of the user's query 601. As the shot, scene, global, transcript, and metadata moments of the video are stored in the vector database 602 as vector embeddings, the hierarchical video intelligence system can compare the feature vector of the user's query 601 to the vector embeddings of the shot, scene, global, transcript, and metadata moments via a search function, including but not limited to a similarity search, semantic search, or multi-modal search. Once the search is performed, the hierarchical video intelligence system retrieves the most relevant information as context. The hierarchical video intelligence system then ingests the user's query 601 and the context into a machine learning model 603 to generate a response.

The response is then displayed to the user via a GUI 604 on a device (e.g., laptop, cell phone, mobile phone, smart phone, computer, tablet, wearable electronic device). The response along with the user's query 601 may be displayed with other information including additional information or related suggested questions related to the video. The GUI 604 may also include a display region 605 for the user to input a new query. The hierarchical video intelligence system may allow for the user to enter any query as a free-text user interface via display region 605.

By way of non-limiting example, a user's query 601 may be “What is the video about?” The hierarchical video intelligence system implements Video-RAG by taking this query 601 inputting it into the machine learning model to create a feature vector for “What is the video about?” and searching for related shot, scene, global, transcript, and metadata moments in the vector database 602. Because “What is the video about?” is a general question about the video, the hierarchical video intelligence system may retrieve the global moment as context. However, if the query was “What were the three personal stories shared by the speaker?” the hierarchical video intelligence system may retrieve scene moments and shot moments related to “connecting the dots, love and loss, and death and life” as context. The hierarchical video intelligence system then inputs the query 601 and the context into a machine learning model 603 to generate the answer to “What is the video about?” as seen on the representation of the GUI 604 in FIG. 6.

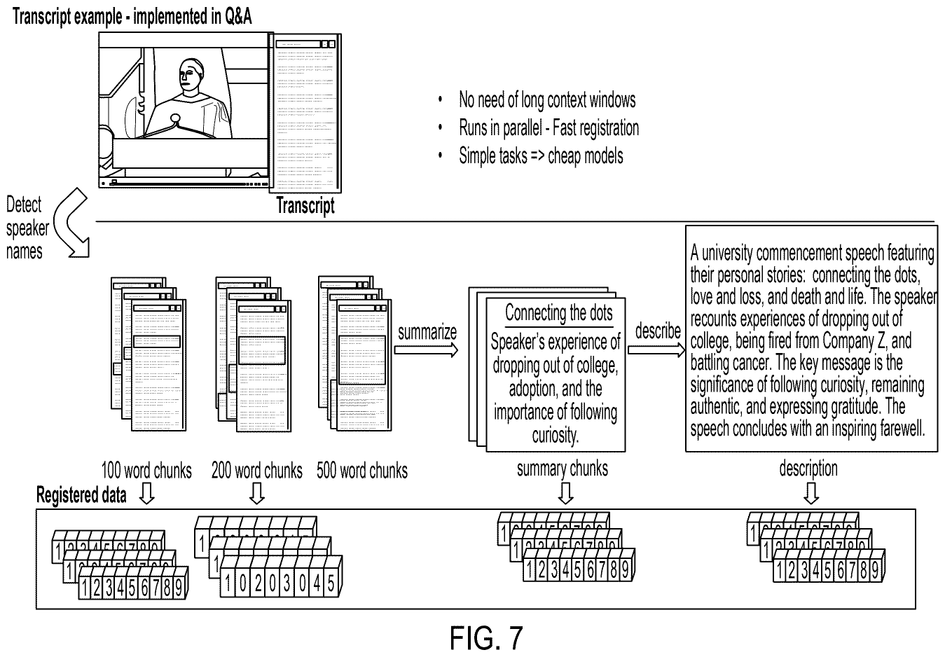

FIG. 7 illustrates another aspect of the disclosure of a system implementing a method for providing access to content information of a video. In particular, this aspect describes processing the transcript into transcript moments which may be used on their own or together with shot, scene, and global moments as described herein. Because transcripts are text based, this method for providing access to content information of a video is simplified: there is no need for long context windows, the transcript processing can run in parallel with other video processing, such as analyzing and detecting shots and scenes and creating shot, scene and global moments, allows for fast registration and storage in the vector database, and transcript processing reduces cost and can utilize cheaper and less resource intensive machine learning models.

By way of example, the hierarchical video intelligence system may first divide the transcript into various sized segments such as 100-word chunks, 200-word chunks, and 500-word chunks. These segments may or may not be associated with shot, scene and global moments of the video. The hierarchical video intelligence system then may input the different sized transcript segments into a machine learning model which is configured to summarize the different sized segments as summary chunks. The hierarchical video intelligence system may then input the summary chunks into the machine learning model which is configured to describe the overall content of the video, similar to a global moment. Because the transcript segments, summary chunks, and transcript description are all text based, they may be stored in the vector database as feature vectors. As a result, the transcript moment in various aspects of the disclosure may include one or more of the transcript segments, summary chunks, and transcript description.

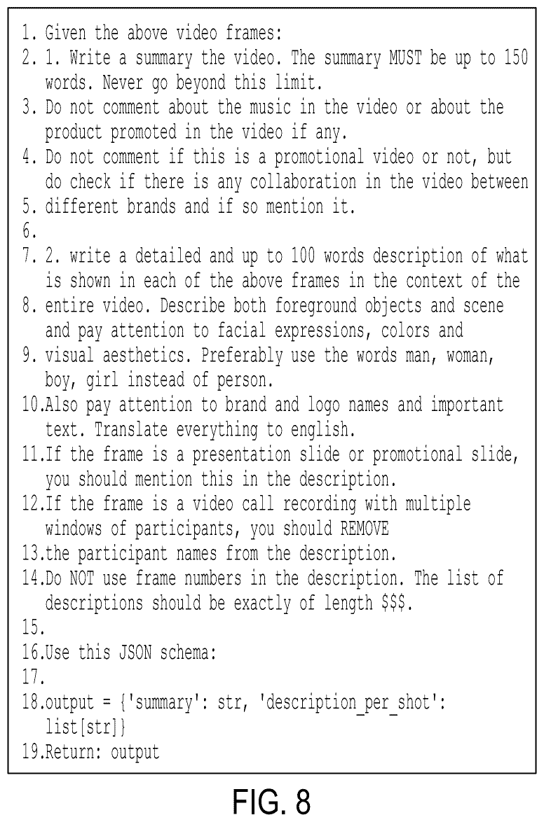

FIGS. 8-14 illustrate aspects of the disclosure of a hierarchical video intelligence system using prompts to generate shot moments, scene moments, and global moments for a video via a machine learning model. The prompts disclosed herein are intended to be non-limiting. Other prompts may be used with the hierarchical video intelligence system to achieve the same effect to generate shot moments, scene moments, global moments for a video via a machine learning model. Prompts may include instructions to generate shot, scene, global, transcript, and metadata moments. The instructions to generate shot moments may include references to the corresponding shots and/or the transcript. The instructions to generate scene moments may include references to the corresponding scenes and/or the transcript. The instructions to generate global moments may include references to the corresponding shots, scenes and/or the transcript. The instructions to generate metadata moments may include references to the corresponding shots, scenes and/or the transcript. The instructions for prompts may have other features, such as those seen in non-limiting FIGS. 8-14, including but not limited to: number of words; shots, scenes, transcripts and/or other moments (e.g., metadata, global moments) to reference; tone of voice (e.g., factual, informative, persuasive, authoritative, simple); features to highlight or features to avoid or limit referencing (e.g., people, facial expressions, colors, lighting, objects present, logos, company names, animals, music used, tags, emojis, text, facts, dates, numbers); language; output format (e.g., JSON, YAML, TOML, HOCON, NestedText, CSON, XML, CSV, TXT); video type (e.g., presentation slide, commercial, sports video, marketing video, documentary, speech).

The machine learning model may be an LLM, a multi-modal LLM, a VLM, or E2E model. In one aspect, a multi-modal LLM is used, such as Gemini Flash™ based on the following characteristics in Table 1:

TABLE 1

| | | | Price |
|---|---|---|---|
| Model | Feature | Type | (≤128K input tokens) |
| Gemini 1.5 | Multimodal | Image Input | $0.00002/image |
| Flash | | Video Input | $0.00002/second |
| | | Text Input | $0.000001875/1k characters |

However, other LLMs may be used, such as GPT4o-mini™ (no video modality, 7.5 times more expensive for image input, 2 times more expensive for text input than Gemini Flash), as long as they are able to be utilized for Video-RAG and generating moments, such as summarizing scenes and shots and detect speaker names, as described in the various aspects herein. is ×7.5 more expensive and for a text input it is ×2 more expensive than Gemini Flash.

When utilizing an LLM such as Gemini Flash™, videos may be sampled at 1 frame per second (fps). Each video frame accounts for 258 tokens. The audio track is encoded with video frames. The audio track may also be broken down into 1-second chunks that each account for 32 tokens. The video frame and audio tokens may be interleaved together with their timestamps.

FIG. 8 illustrates an aspect of the disclosure of a hierarchical video intelligence system using example prompts to generate shot moments and scene moments via a machine learning model. First, the hierarchical video intelligence system detects the scenes and shots, such as described in FIGS. 1-5. A scene and its corresponding shots are then given to the machine learning model. The prompt shown in FIG. 8 may be then inserted into the LLM, which directs the LLM to output a textual format, via a JavaScrpt Object Notation (JSON) file. The output may be a summary and title representing the entire scene (i.e., a scene moment) and a list of description per shot (i.e., shot moments). Note the description of each shot is impacted from all the other shots as well. It is possible to extract from the shot description if it is a slide or not for further processing. For example, steps 1-5 direct the machine learning model to generate a “summary,” which is generated in the output in the (‘summary’: str) field of the JSON file. This generated summary is the scene moment. Steps 7-14 then direct the machine learning model to generate a “description” for each shot which is generated in the output in the (‘description_per_shot’: list [str]) field of the JSON file. This generated array of descriptions for each shot is the shot moments for the given scene. This JSON representation is one example of representing the shots and scenes in a hierarchical structure capable of use with a vector database with the shot moments at a first level in an array within each scene at a second level. The prompt may be then used to generate corresponding JSON files for each detected scene of a video. However, any prompt capable of generating shot moments and scene moments may be used.

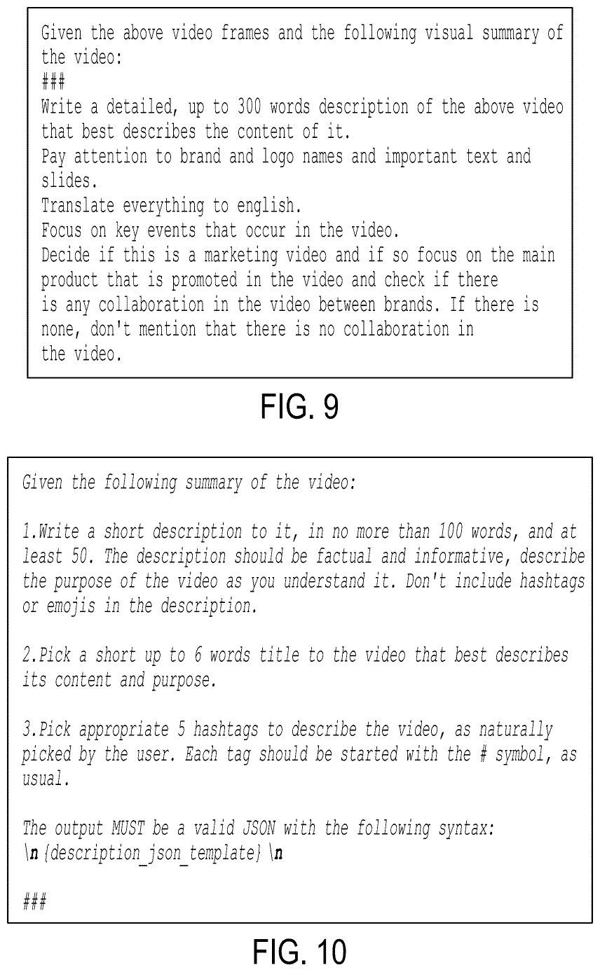

FIG. 9 illustrates an aspect of the disclosure of a hierarchical video intelligence system using an example prompt with shot and scene moments to generate a global moment for a video. First, the hierarchical video intelligence system detects the scenes and shots, such as described in FIGS. 1-5. The shots (i.e., the “above video frames”) of the video are then given to the machine learning model prior to the prompt. One image from each scene may also be sampled and inserted before the prompt. The prompt shown in FIG. 9 is then inserted into the LLM, where “###” is replaced with concatenating the summaries of all the scenes in the video, from the JSON files generated by the machine learning model such as in FIG. 8. The output is a text summary, or global moment, of the visual content of the video. However, any prompt capable of generating global moments may be used.

FIG. 10 illustrates an aspect of the disclosure of a hierarchical video intelligence system using an example prompt with a global moment to generate an exemplary meta-data moment for a video. First, the hierarchical video intelligence system detects the scenes and shots, such as described in FIGS. 1-5. Scene and shot moments are then generated by the machine learning model, such as described in FIGS. 3 and 8. A global moment is then generated by the machine learning model, such as described in FIGS. 3 and 9. The global moment is then presented to the machine learning model ingested in the prompt shown in FIG. 10 by replacing “###” with the global moment. The output may be metadata (e.g., a title, description and tags for the video), which is output as a JSON file. However, any prompt capable of generating meta-data moments may be used.

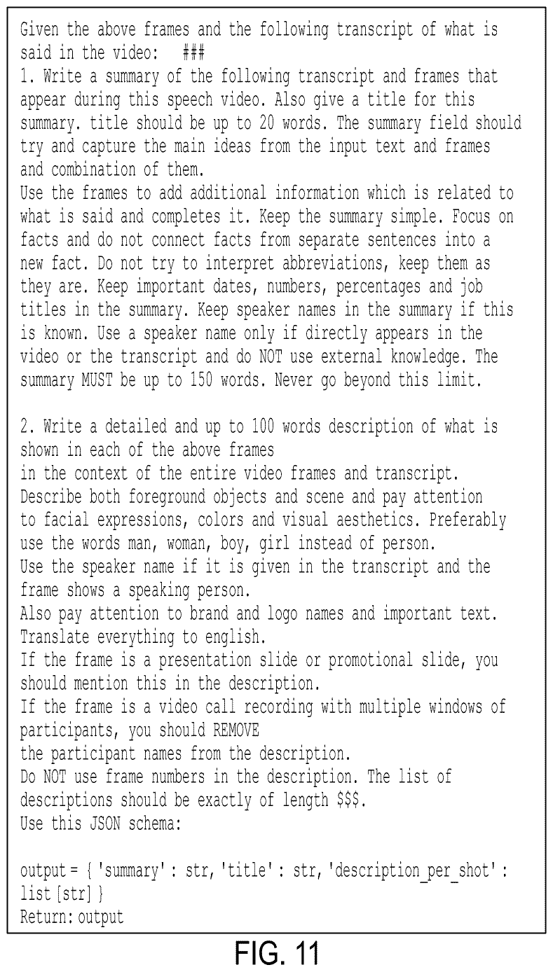

FIG. 11 illustrates an aspect of the disclosure of a hierarchical video intelligence system using an example prompt to generate shot moments and scene moments with an injected transcript via a machine learning model. First, the hierarchical video intelligence system detects the scenes and shots, such as described in FIGS. 1-5. A scene and its corresponding shots are then given to the machine learning model. The prompt shown in FIG. 11 is then presented to the machine learning model along with the transcript corresponding to the scene by replacing “###/” in the prompt. The output may be a summary and title representing the entire scene (i.e., a scene moment) and a list of description per shot (i.e., shot moments). For example, step 1 directs the machine learning model to generate a “summary,” which is generated in the output in the (‘summary’:str) field of the JSON file. This generated summary is the scene moment. Step 2 then directs the machine learning model to generate a “description” for each shot which is generated in the output in the (‘description_per_shot’:list [str]) field of the JSON file. This generated array of descriptions for each shot is the shot moments for the given scene. This prompt is then used to generate corresponding JSON files for each detected scene of a video. However, any prompt capable of generating shot moments and scene moments may be used.

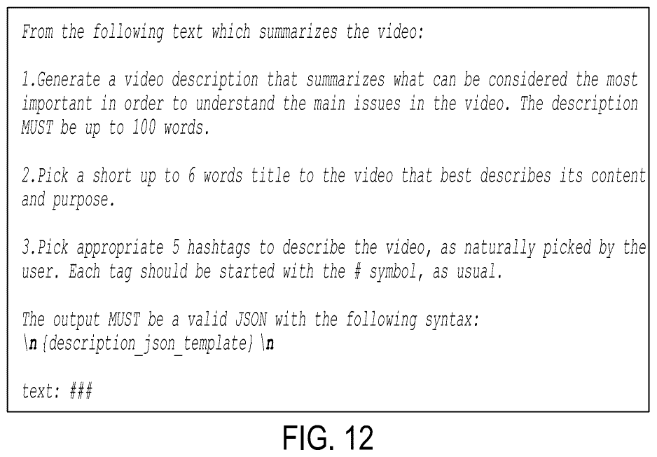

FIG. 12 illustrates an aspect of the disclosure of a hierarchical video intelligence system using an example prompt and scene moments to generate a global moment and an exemplary meta-data moment for a video. First, the hierarchical video intelligence system detects the scenes and shots, such as described in FIGS. 1-5. Scene and shot moments are then generated by the machine learning model, such as described in FIGS. 3, 4 and 8. The scenes are then presented to the machine learning model ingested in the prompt shown in FIG. 12 by replacing “###” with the scene moments from the JSON files as described in FIGS. 8 and 11. The output may include a description (i.e., the global moment) and metadata (e.g., a title and tags for the video), which is output as a JSON file.

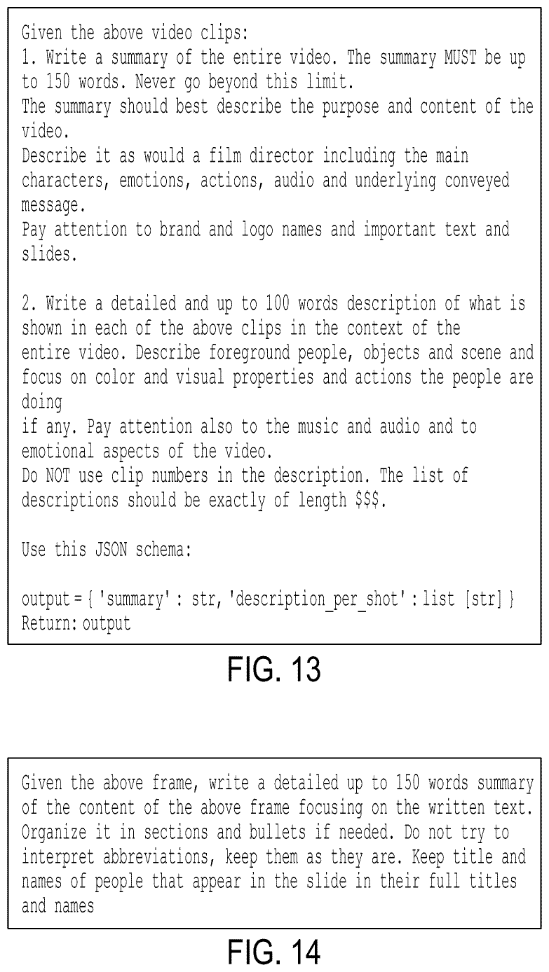

FIG. 13 illustrates an aspect of the disclosure of a hierarchical video intelligence system using an example prompt to generate shot moments and global moments via a machine learning model. This aspect may be particularly useful for shorter videos, such as videos less than or equal to 5 minutes in length. First, the hierarchical video intelligence system detects the shots, such as described in FIGS. 1-5. In particular, the hierarchical video intelligence system may detect the scenes and/or shots by using video cuts/transitions in order to sample clips on either side of the video cuts and/or transitions as described herein. The scenes and/or shots are then provided to the machine learning model along with the example prompt of FIG. 13 to generate shots and scene moments. In this prompt, the machine learning model is instructed to focus on more high level information such as music, actions and emotional aspects. The output may be a summary representing the entire video (i.e., a global moment) and a list of description per shot (i.e., shot moments). For example, step 1 directs the machine learning model to generate a “summary,” which is generated in the output in the (‘summary’: str) field of the JSON file. This generated summary is the global moment. Step 2 then directs the machine learning model to generate a “description” for each shot which is generated in the output in the (‘description_per_shot’: list [str]) field of the JSON file. This generated array of descriptions for each shot is the shot moments for the video. However, any prompt capable of generating shot global moments may be used.

FIG. 14 illustrates an aspect of the disclosure of a hierarchical video intelligence system using an example prompt to generate shot moments via a machine learning model. This aspect may be particularly useful for shots that include only or primarily text, such as presentation slides. First, the hierarchical video intelligence system detects the shots, such as described in FIGS. 1-5 with limiting including details other than text such as multi-participant video-meeting windows (which may confuse the machine learning model and cause the machine learning model to extract distracting information about the shot). Each shot is then given to the machine learning model with the prompt shown in FIG. 14 to get a document-understanding of the slide. The generated description is used to create a shot moment that now focuses on the “textual” part of the shot and tries to extract as much possible information about it. However, any prompt capable of generating shot moments may be used.

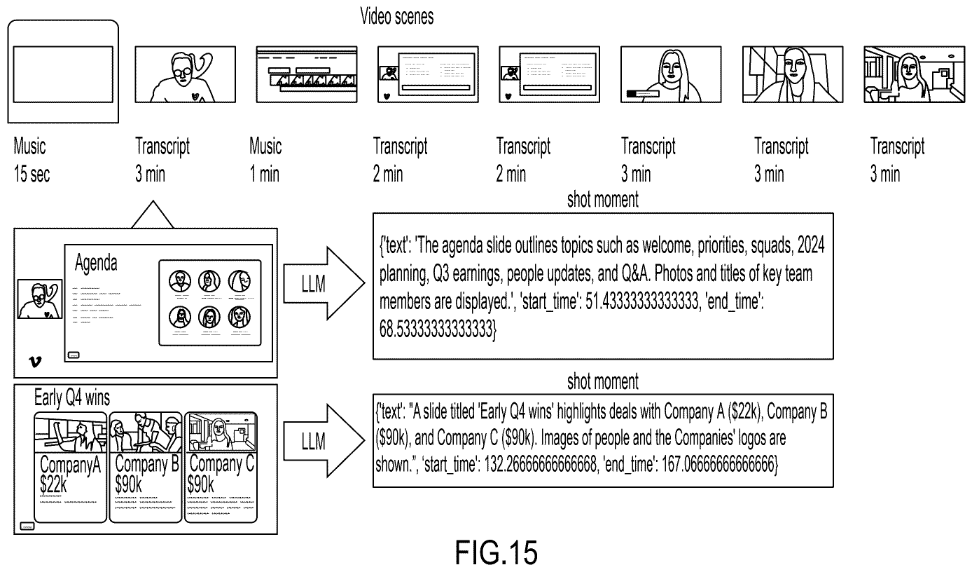

Note that this is different than optical character recognition (OCR) because machine learning models can understand tables, images near the text and therefore give a better semantic meaning to the text. Exemplary shot moments of a slide presentation may be seen in FIG. 15, where the produced JSON files for the shot moments begin with (‘text’:) based on the prompt described in FIG. 14. Thus the machine learning model as compared to OCR understands that the layout and relation between the texts and images importance and creates the appropriate descriptions.

In another aspect of the disclosure, each moment (e.g., shot moment, scene moment, global moment, transcript moment) generated by the machine learning model includes metadata in addition to the textual description of the moment including the start time (in milliseconds), the end time (in milliseconds), the vector embedding of the text (i.e., numerical representation of the textual description), and tags that describe the moment. The metadata may be a part of the moment in a JSON file or included as a separate metadata moment paired with the shot, scene, global, or transcript moment, such as described in FIG. 10 for example.

In another aspect of the disclosure, various attributes may be used as shown in Table 2 below.

TABLE 2

| Attribute | | |
|---|---|---|
| name | Meaning | Hierarchy |
| transcript | raw transcript chunks | |
| | (few sentences | |
| | 100-200 words) | |
| scene | a video part which does not have | |
| | speech | |
| chapter | a video part which has speech | |
| shot | a smaller video part within the | |
| | scene/chapter which is mostly | |
| | static (e.g. a slide) | |
| is_speech | | transcript, chapter |
| is_visual | | shot, scene |
| is_localized | | transcript, chapter, |
| | | shot, scene |
| video_summary | a long summary of the video | |
| description | a short summary of the video | |
| title | suggested title for the video | |
| tags | Suggested social hashtags for | |
| | the video | |
| video_details | | video_summary, |
| | | description, |
| | | title, tags |

In another aspect of the disclosure, a hierarchical video intelligence system may be able to use speech diarization techniques as described herein to detect speakers and/or scenes within a video without using facial recognition. Speech diarization is particularly useful for knowledge-sharing videos through formats such as corporate or sales meetings, questions are often aimed at particular speakers. Further, speech diarization techniques assist hierarchical video intelligence system to implement other applications such as described in FIGS. 5 and 6 in implementing Video-RAG.

Speech diarization also enables the hierarchical video intelligence system to access name data for speakers without referring to auxiliary sources because this information is often not provided as metadata within a video, nor is it associated or uploaded in connection to the video content. Further, speech diarization techniques assist in extracting speaker information based on context found within an unstructured format (e.g., a video transcript or unprocessed video), which simply transcribes what everyone is saying without specifying which individuals are saying what.

Consider the following example, Pumbaa, a warthog, says, “I ate like a pig,” to which Simba replies, “Pumbaa, you are a pig.” The goal with the speech diarization techniques of the disclosure is to convert the unstructured format (e.g., transcript) into a structured dialog to identify the name and the order of the speakers in a conversation. The hierarchical video intelligence system may first segment the conversation to different speakers by clustering the audio found within the video. For example, the hierarchical video intelligence system may cluster the audio using known clustering techniques such as Agglomerative Hierarchical Clustering (AHC), k-Means, Mean-shift, spectral-based network, or autoencoder-based systems such as DCN, DAMIC, or k-DAE. The result is that each sentence may be associated with a specific numerical speaker ID:
Speaker 1: “I ate like a pig.”
Speaker 2: “Pumbaa, you are a pig.”

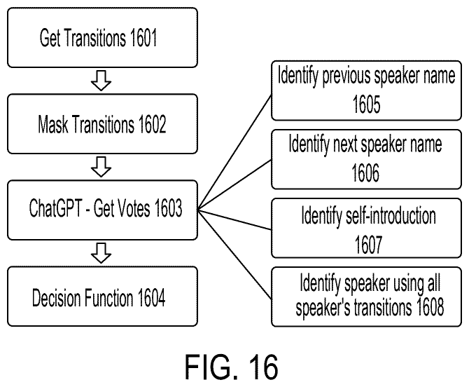

The hierarchical video intelligence system then identifies the name associated with each speaker ID as shown in FIG. 16. Unstructured transcripts consisting of free speech often feature multiple name references in a single sentence or mention a speaker who isn't included in the conversation. In informal discussions, some speakers might not be identified by name, or various names or nicknames could be used to refer to the same individual, and so on, and so on. The most common place to find the names of speakers in conversational videos is during conversation transitions from one person to another. These transitions, characterized by the handover of conversational turns between participants, hold a lot of name data. These are the areas in the conversation where it's most common to find a speaker's self-introduction, one speaker presenting the next speaker, or a speaker thanking the previous speaker.

A first step to identify a name with a speaker ID in an embodiment of the disclosure focuses on identifying and isolating speaker transitions and extracting the names of speakers from these transitions at 1601. Conversation transitions may be delineated for example, when one speaker identifies another speaker's name, when one speaker identifies their own name, or when a speaker references a speaker by a pronoun. For example, for a conversation transition between Pumbaa and Simba, it can be seen that Simba refers to Pumbaa by name, so it's possible to conclude the name of the first speaker:
Pumbaa: “I ate like a pig.”
Speaker 2: “Pumbaa, you are a pig.”

The hierarchical video intelligence system may then mask the statement of the identified speaker at 1602. For example, one can disregard or mask Pumbaa's statement without affecting name identification:
Pumbaa: [-]
Speaker 2: “Pumbaa, you are a pig.”

In an aspect of the disclosure the hierarchical video intelligence system then may use a machine learning model, such as a LLM (e.g., ChatGPT™), to analyze the text around speaker transitions and associates names to speakers at 1603. The hierarchical video intelligence system uses the machine learning model as a name detection mechanism by basing on votes generated. For every transition, the hierarchical video intelligence system prompts the machine learning model to identify speaker names by analyzing each side of the transition individually. This is achieved by masking the first or second speaker based on the prompt type (e.g., 1605-1608), which is effective in reducing the noise of irrelevant names and reducing the context provided to the machine learning model.

The embodiment also asks for an identification based on all transitions attributed to a single speaker. Each identification corresponds to one vote. The embodiment then applies a decision function to remove any errors in the voting in aggregate and determine if the speaker's name corresponding to the numerical ID can be established with a high level of confidence at 1604. Voting in the aggregate is used because when decisions are made based on just one vote, there may be a significant increase in the likelihood of misidentification of the speaker. Preferably, assigning a name to a speaker ID should only be done when there is a high degree of certainty in the accuracy of the identification. It is preferred to leave the speaker's name unspecified rather than attributing an incorrect name.

As shown in FIG. 16 the hierarchical video intelligence system may use four different prompts to the machine learning model to determine the name votes for each speaker ID. For example, prompt 1605 may provide a query to the machine learning model to identify the name of Speaker 2 from what Speaker 1 just said, where the text of Speaker 2 is masked in step 1602:
Speaker 1: “Take it away, Rachel.”
Speaker 2: [-]

Prompt 1606 may provide a query to the machine learning model to identify the name of Speaker 1 from what Speaker 2 says immediately afterward, where the text of Speaker 1 is masked in step 1602:
Speaker 1: [-]
Speaker 2: “Thanks, David.”

Prompt 1607 may provide a query to the machine learning model to identify if a speaker is giving a self-introduction:
Speaker 2: “Hi, everyone, great to be here. My name is Rachel.”

Prompt 1608 may provide a query to the machine learning model to identify the name of a specific speaker by passing all transitions of a single speaker at once. For example, to deduce Speaker 2 is Simba from the previous example conversation, additional transitions from the transcript from different contexts earlier and later in the video may be provided:
Speaker 3: “Whoa! Nice one, Simba.”
Speaker 2: “Thanks. Man, I'm stuffed.”
Speaker 1: “Me too. I ate like a pig.”
Speaker 2: “Pumbaa, you are a pig.”
Speaker 1: “Simba, what do you think?”
Speaker 2: “Well, I don't know.”

So from these transitions of Speaker 2, the LLM can deduce that Speaker 2 is actually
Simba. This has now yielded a structured transcript:
Pumbaa: “I ate like a pig.”
Simba: “Pumbaa, you are a pig.”

The hierarchical video intelligence system may use one or more of the prompts 1605-1608 to the machine learning model and may use the prompts 1605-1608 iteratively in any order depending on the transcript to identify the speakers.

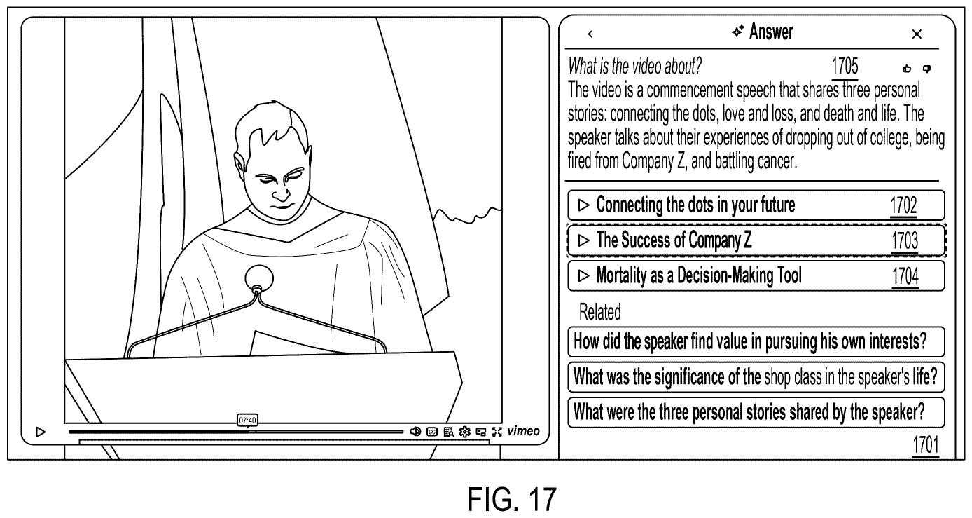

FIG. 17 illustrates another aspect of the disclosure, where the hierarchical video intelligence system may provide suggested playable moments 1702-1704 via a GUI 1701 when implementing Video-RAG, such as seen in FIGS. 5 and 6. For example as seen in FIG. 17, the hierarchical video intelligence system may render, in a display of a user device, the GUI 1701 comprising a video pane and a context pane, where the video pane displays a user selected video. The hierarchical video intelligence system then obtains, from the database, the shot moments, the scene moments, and the global moment corresponding to the user selected video and renders in the context pane at least one of: at least one selectable playable moment corresponding to a respective scene moment or a respective shot moment, a user query input field; and a user query output field. The hierarchical video intelligence system may also receive a user query via the user query input field, retrieve from the database, based on the user query, one or more relevant moments from among the shot moments, the scene moments, and the global moment of the user selected video using Video-RAG and then render, in association with results responsive to the user query, textual content derived from the relevant moments in the user query output field or at least one selectable playable moment 1702-1704 corresponding to a moment related to the results responsive to the user query 1705.

There is significant value in not only answering a user's query 1705, see also FIG. 6, in a textual fashion but also referring the viewer to watch moments 1702-1704 in the video that support the answer. These playable moments 1702-1704 may convey additional information that may not necessarily appear in the textual answer of “What is the video about?”, including details that were left out, but also visual information, tone of voice, music, emotions, and other potentially relevant factors. Relevant playable moments 1702-1704 may be cued up when the viewer asks a question about a video. The hierarchical video intelligence system may automatically play the playable moments 1702-1704 after a period of time, such as 1 minute, 5 minutes, or may play the playable moments 1702-1704 when a user selects the playable moment 1702-1704 via the GUI 1701.

The hierarchical video intelligence system may separate the tasks of answering questions 1705 (see also FIG. 6) and finding references to answers within a video (via playable moments 1702-1704) rather than trying to perform both tasks in the same prompt. Separating the tasks of answering questions and finding references to the answers leads to better performance because a first answer provides clean context to get clean and accurate answer 1705 and the answer is matched to the difference source found via playable moments 1702-1704.

In an aspect of the disclosure, the hierarchical video intelligence system may utilize two prompts via Video-RAG to cause the machine learning model to generate an answer 1705 and playable moments 1702-1704. The first prompt may answers the question 1705 (see also FIG. 6), followed by a second prompt that finds the relevant quotes in the transcript (and/or finds relevant visual shots) given the question and answer to provide playable moments 1702-1704. Both prompts refer to the same context retrieved from the database, such as described in FIG. 6. The first prompt uses the text that was stored in the database (whether it's a transcript text and/or a processed text summary as described above) to generate the answer 1705. The second prompt may use the original transcript text that was stored in the database, to find quotes that actually appear in the video for the playable moments 1702-1704.

In another aspect of the disclosure, to make the second prompt more efficient, the chat answer may be embedded to a vector representation and then the hierarchical video intelligence system may compute the answer's similarity with all the retrieved matches that formed the original context to the question. Once retrieved, new context may provided to the machine learning model with the prompt that consists of only the matches that had enough similarity with the chat answer. This also helps guarantee a higher confidence that the extracted quotes do indeed align with the chat answer for the playable moments 1702-1704.

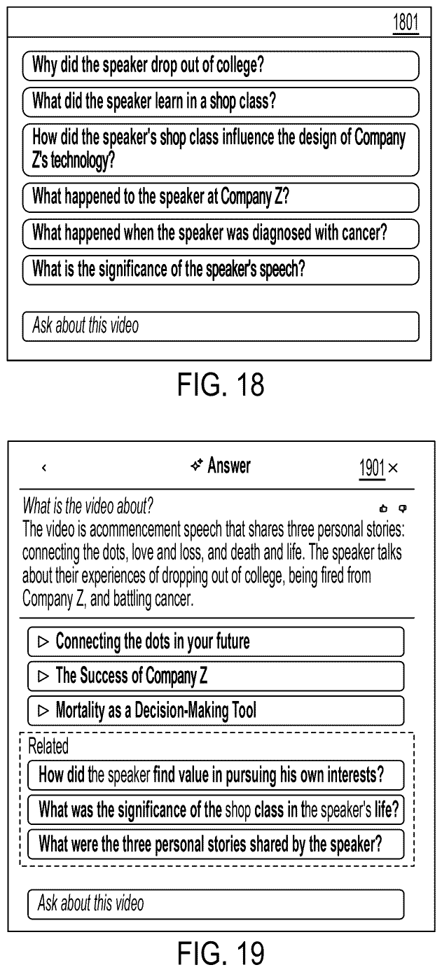

FIG. 18 illustrates another aspect of the disclosure, where the hierarchical video intelligence system may achieve an engaging viewer experience by populating a chatbot via GUI 1801 with several pre-generated questions and answers prior to any user query provided. The goal is to enable viewers who don't know what questions to ask, or who feel overwhelmed by having to think of a question to experience the Q&A product. The hierarchical video intelligence system may compute these pre-generated questions and answers during the transcript registration process and may be performed in the same way that the hierarchical video intelligence system generates the video description, shot moment, scene moment, or global moments such as described in FIGS. 8-15. For example, The hierarchical video intelligence system may utilize a prompt that takes all the shot moments or scene moments and ingests them into the machine learning model with a request to generate the most important question-answer pairs about the video based on the shot moments or scene moments.

As seen in FIG. 19, if the viewer already asked a question or selected via GUI 1901 one of the pre-generated questions, the hierarchical video intelligence system may keep the user engaged by suggesting more related questions that can be asked on the same topic. However, it is preferred that the related questions that have been pre-generated are questions that may be answered in the context of the video. Otherwise, since this is a closed-world scenario, if the machine learning model is only asked to create related questions given only the user question, there is no guarantee that those can be answered by implementing Video-RAG of the disclosure.

The hierarchical video intelligence system may use Video-RAG also for creating these questions. To do so, the hierarchical video intelligence system embeds the user query (e.g., “What is this video about?”) to a vector representation, just like described above. The hierarchical video intelligence system may then retrieve from the vector database relevant context based on its similarity to the user query, such as in FIG. 6. Part of the retrieved matches may be new unseen matches that are close to the answer of the user's query, although they may not be close to the user's query. This process enables the hierarchical video intelligence system to widen the context regarding topics that are close to the original question. Finally, the hierarchical video intelligence system may then prompt the machine learning model to create related questions that are related to the topic of the original viewer question, are not already answered in the answer, and can be answered from the given retrieved context. Then, the hierarchical video intelligence system displays related questions to the user via GUI 1901. Each of the processes, methods, and algorithms described in the preceding sections may be embodied in, and fully or partially automated by, code modules or as part of an API executed by one or more computers or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel or in some other manner. Blocks or states may be added to or removed from the disclosed example embodiments. The example systems and components described herein may be configured differently than described. For example, elements may be added to, removed from, or rearranged compared to the disclosed example embodiments.

It will also be appreciated that various items are illustrated as being stored in memory or on storage while being used, and that these items or portions of thereof may be transferred between memory and other storage devices for purposes of memory management and data integrity. Alternatively, in other embodiments some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions or structured data) on a computer-readable medium, such as a hard disk, a memory, a network, or a portable media article to be read by an appropriate drive or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present disclosure may be practiced with other computer system configurations.

Some portions of the above description present the features of the present disclosure in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

The present disclosure also relates to a system for performing the operations described herein. This system may be specifically constructed for the required purposes, or the apparatus or system can comprise a general-purpose system selectively activated or configured/reconfigured by a computer program stored on a computer program product as discussed herein that can be accessed by a computing system or other device.

Those of skill in the art will readily recognize that the algorithms and operations presented herein are not inherently related to any particular computing system, computer architecture, computer or industry standard, or any other specific apparatus. Various general-purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present disclosure is not described with reference to any particular programming language and it is appreciated that a variety of programming languages may be used to implement the teachings of the present disclosure as described herein, and any references to a specific language or languages are provided for illustrative purposes only and for enablement of the contemplated best mode of the invention at the time of filing.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without author input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example embodiments have been described, these embodiments have been presented by way of example only and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

1. A method for providing access to content information of a video, comprising:
detecting, by one or more processors, a set of scenes from the video;
detecting one or more shots for each scene of the set of scenes utilizing a sample rate that is adaptive based on one or more of, content of the video or duration of the video;
analyzing the scenes and shots by using at least one machine learning model configured to generate a textual description of the analyzed shots and scenes;
storing the textual descriptions of the shots and scenes respectively as shot moments and scene moments in a database;
generating, based on the scene moments or the shot moments, a global moment configured to provide an overall context of the video; and
storing the global moment with the shot moments and the scene moments in the database in a hierarchical structure;
wherein shot moments are stored in a first lower level of the hierarchical structure, the global moments are stored in a third a higher level of the hierarchical structure and the scene moments are stored in a second mid-level of the hierarchical structure between the first lower level and the third higher level.

2. The method of claim 1, wherein the storing steps include registering the shot moments, scene moments and global moment into a vector database.

3. The method of claim 2, wherein the registering uses multi-modal video retrieval augmented generation (RAG) architecture.

4. The method of claim 1, further comprising identifying names associated with speakers in the video.

5. The method of claim 1, further comprising retrieving data associated with the video using semantic searching.

6. The method of claim 1, further comprising retrieving data associated with the video using a question and answer application.

7. The method of claim 4, wherein speaker detection includes the following steps:
clustering an audio portion of the video into sets of different speakers, each having a speaker ID, and labeling each sentence in the transcript with a corresponding speaker ID;
identify transitions in the transcript where a handover of conversation occurs between different speakers;
for every transition, using a machine learning model to identify speaker names by analyzing each side of the each transition and masking one or more speaker names based on the prompt type;
for each identified speaker name, counting a number of transitions attributed to the speaker; and
using the counts, removing with the assistance of a decision function potential identification errors that are not established with a predetermined confidence level.

8. The method of claim 6, wherein the question and answer application populates a chatbot with several pre-generated questions and answers.

9. The method of claim 8, wherein the pre-generated questions and answers are generated during the registering step by using a machine learning model to generate question-answer pairs from the shot moments, scene moments and/or global moment.

10. The method of claim 8, wherein:
wherein the storing steps include registering the shot moments, scene moments and global moment into a vector database;
the registering uses multi-modal video retrieval augmented generation (RAG) architecture; and
the retrieval augmented generation (RAG) architecture is also used to create chat answers that are saved in the vector database.

11. The method of claim 10, further comprising querying the vector database for widening the chat conversation based on the original question-answer pair.

12. The method of claim 8, wherein a machine learning model is used to create questions related to the pre-generated questions, wherein the related questions have one or more of the following characteristics: the related question is related to the topic of the original viewer question; the related question is not already presented in the chat answer; and/or the related question can be answered from the given retrieved content.

13. The method of claim 1, wherein each of the scenes are detected using speaker diarization and/or using video transitions and/or using video cuts.

14. The method of claim 1, further comprising determining a length of time for each of the detected scenes prior to analyzing the scenes by the machine learning model;
if the length of time of the detected scene is less than the threshold time length, combine the detected scene with a next proceeding detected scene until the scene has a length of time equal to or greater than the threshold time length; and
if the length of time of the detected scene is equal to or greater than the threshold time length, proceed to analyze the scene by the machine learning model.

15. The method of claim 1, further comprising dividing a transcript of the video into transcript segments associated with each of the scenes and/or each of the shots.

16. The method of claim 1, wherein content of the video is determined based on the presence of static content versus the presence of dynamic content.

17. The method of claim 1, further comprising:
rendering, in a display of a user device, a graphical user interface comprising a video pane and a context pane, wherein the video pane displays a user selected video;
obtaining, from the database, the shot moments, the scene moments, and the global moment corresponding to the user selected video; and
rendering, in the context pane at least one of: (i) at least one selectable playable moment corresponding to a respective scene moment or a respective shot moment, (ii) a user query input field; and (iii) a user query output field.

18. The method of claim 17, further comprising
receiving a user query via the user query input field;
retrieving from the database, based on the user query, one or more relevant moments from among the shot moments, the scene moments, and the global moment of the user selected video;
rendering, in association with results responsive to the user query, textual content derived from the relevant moments in the user query output field or
rendering at least one selectable playable moment corresponding to a moment related to the results responsive to the user query.

19. The method of claim 18, wherein retrieval augmented generation (RAG) architecture is used in the retrieving and rendering steps.

20. The method of claim 14, wherein the threshold time length is a fixed time threshold.

21. The method of claim 14, wherein the threshold time length is a percentage time threshold.

22. A method for detecting speakers in a video comprising:
clustering an audio portion of a video into sets of different speakers, each having a speaker ID, and labeling each sentence in the transcript with a corresponding speaker ID;
identify transitions in the transcript where a handover of conversation occurs between different speakers;
for every transition, using a machine learning model to identify speaker names by analyzing each side of each transition and masking one or more speaker names based on the prompt type;
for each identified speaker name, counting a number of transitions attributed to the speaker; and
using the counts, removing with the assistance of a decision function potential identification errors that are not established with a predetermined confidence level.

23. A system for providing access to content information of a video, comprising:
a vector database;
one or more machine learning models; and
one or more computing systems configured to:
detect a set of scenes from a video;
detect one or more shots for each scene of the set of scenes utilizing a sample rate that is adaptive based on one or more of, content of the video or duration of the video;
analyze the scenes and shots by using the least one machine learning model configured to generate a textual description of the analyzed shots and scenes;
store the textual descriptions of the shots and scenes respectively as shot moments and scene moments in the vector database;
generate, based on the scene moments or the shot moments, a global moment configured to provide an overall context of the video; and
store the global moment with the shot moments and the scene moments in the vector database in a hierarchical structure;
wherein shot moments are stored in a first lower level of the hierarchical structure, the global moments are stored in a third a higher level of the hierarchical structure and the scene moments are stored in a second mid-level of the hierarchical structure between the first lower level and the third higher level.

24. One or more non-transitory memories including computer instructions for instructing one or more processors to perform the steps comprising:
detecting a set of scenes from the video;
detecting one or more shots for each scene of the set of scenes utilizing a sample rate that is adaptive based on one or more of, content of the video or duration of the video;
analyzing the scenes and shots to generate a textual description of the analyzed shots and scenes;
storing the textual descriptions of the shots and scenes respectively as shot moments and scene moments in a database;
generating, based on the scene moments or the shot moments, a global moment configured to provide an overall context of the video; and
storing the global moment with the shot moments and the scene moments in the database in a hierarchical structure;
wherein shot moments are stored in a first lower level of the hierarchical structure, the global moments are stored in a third a higher level of the hierarchical structure and the scene moments are stored in a second mid-level of the hierarchical structure between the first lower level and the third higher level.
